(19) United States
(12) Patent Application Publication
(10) Pub. No.: US 2008/0267152 A1
(43) Pub. Date: Oct. 30, 2008

(54) MULTIMEDIA BROADCAST/MULTICAST SERVICE (MBMS) SERVICE DISCOVERY

(76) Inventors: Svante Alnas, Lund (SE); Olle Franceschi, Landskrona (SE); Zhengrong Yao, Landskrona (SE)

Correspondence Address: ERICSSON INC., 6300 LEGACY DRIVE, M/S EVR 1-C-11, PLANO, TX, 75024, US

(21) Appl. No.: 12/040,962

(22) Filed: Mar. 3, 2008

Related U.S. Application Data
(60) Provisional application No. 60/892,965, filed on Mar. 5, 2007.

(51) Int. Cl. H04Q 7/00

(52) U.S. Cl. 370/338

(57) ABSTRACT

A system and method for discovery of and access to service in a Multimedia Broadcast/Multicast Service (MBMS) environment by user equipment (UE) when roaming. The UE may be associated with a plurality of URLs including a home URL and a symbolic URL. When the UE is roaming, the symbolic URL is resolved by a local DNS server to a local URL that is assessed by a local Service Discovery server to determine the MBMS services that may be accessed by the UE in the visiting network. Further, when roaming, the home URL is resolved by the local DNS server and forwarded to a home Service Discovery server where the home URL is assessed to determine the MBMS services that may be accessed by the UE in the home network. Accordingly, the UE is operable to access home network MBMS services as well as visiting network MBMS services when roaming.

### CROSS-REFERENCE TO RELATED APPLICATIONS

This application claims the benefit of U.S. Provisional Application No. 60/892,965, filed Mar. 5, 2007, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to Multimedia Broadcast/Multicast Service (MBMS) service discovery. More particularly, and not by way of limitation, the present invention is directed to a system and method for discovery of and access to service in an MBMS environment by user equipment (UE) when roaming.

In the related art, much activity has recently focused on methods for transmitting data from a single source to several destinations known as point-to-multipoint transmissions. In one such method, a Multimedia Broadcast/Multicast Service (MBMS) service is realized by the addition of a number of new capabilities to current functional entities of the Third Generation Partnership Project (3GPP) architecture, and by the addition of a number of new functional entities.

In the 3GPP architecture, the MBMS feature is split into an MBMS Bearer Service and an MBMS User Service. The MBMS Bearer Service includes a Multicast and a Broadcast Mode. The MBMS Bearer Service uses (Internet Protocol) IP Multicast addresses for the IP flows. In so much, the existing packet switching (PS) Domain functional entities are enhanced to provide the MBMS Bearer Service.

In a broadcast mode using the MBMS service, a unidirectional point-to-multipoint transmission may be provided for multimedia data, for example, text, audio, picture, and/or video, from a single source in a network to all users in the network area or areas. The MBMS service may be provided through a broadcast channel since a number of UEs may receive the same MBMS service.

A key element in such a system is service discovery; that is, how the UE determines which MBMS services are available in a given network, and how the UE may use and attach to the MBMS services.

Currently, in the Open Mobile Alliance Mobile Broadcasting Services standard (OMA BCAST), OMA device management (DM) is used to discover services using a MBMS Bearer. The OMA DM protocol specifies the protocol for transferring management actions between a client and a management server, and the Extensible Markup Language (XML) elements to be used in the messages, thus enabling consistent functioning of different devices supporting the protocol. This process for discovery of MBMS services works in the home network of the UE.

However, problems may arise when the UE roams to a visiting network and wants to access the local MBMS services in the visiting network. Using DM to update the UE for discovering the MBMS services in a visiting network is a complex issue and currently, there is no easy to deploy a general solution for this issue.

### BRIEF SUMMARY OF THE INVENTION

The present invention, in exemplary embodiments, overcomes the above disadvantages and other disadvantages not described above. Also, the present invention is not required to overcome the disadvantages described above, and an exemplary embodiment of the present invention may not overcome any of the problems described above.

Thus, in one aspect, the present invention is directed to a method for discovering and accessing Multimedia Broadcast/Multicast Service (MBMS) services by a roaming user equipment (UE). The method comprises receiving a request from the UE to discover one or more of the MBMS services, wherein the request includes a plurality of Uniform Resource Locators (URLs). The URLs may include a home URL and a symbolic URL. Further, in response to receiving the request, the method includes assessing the URLs to determine the MBMS services that the UE may access.

In another aspect, the present invention is directed to a MBMS system, comprising UE operable in a roaming environment, and a plurality of Domain Name System (DNS) servers and Service Discovery servers. The UE may include a transmitter structured to transmit a MBMS service discovery request, wherein the service discovery request may include a plurality of Uniform Resource Locators (URLs) associated with the UE, the URLs including a home URL and a symbolic URL. The plurality of DNS servers may be structured to receive and resolve the URLs transmitted by the UE. Further, the plurality of Service Discovery servers may be structured to receive the resolved URLs and assess the MBMS services that may be accessed by the UE.

In yet another aspect, the present invention is directed to a UE operable to discover and access MBMS services in a roaming environment. The UE may comprise a transmitter and a receiver. The transmitter may be structured to transmit a MBMS service discovery request, the service discovery request including a plurality of URLs associated with the UE, the URLs including a home URL and a symbolic URL. The receiver may be operable to access the MBMS services in both a home and visiting network during roaming.

### BRIEF DESCRIPTION OF THE SEVERAL VIEWS OF THE DRAWING

In the following section, the invention will be described with reference to exemplary embodiments illustrated in the figures, in which:

FIG. 1 illustrates a User Equipment (UE) according to an exemplary embodiment of the present invention;

FIG. 2 illustrates a Multimedia Broadcast/Multicast Service (MBMS) system wherein a roaming UE is operable to access a home network and visiting network of the system, according to an exemplary embodiment of the present invention,

FIG. 3 is a flowchart of a method for discovering and accessing MBMS services by a UE in a home network, according to an exemplary embodiment of the present invention; and

FIG. 4 is a flowchart of a method for discovering and accessing MBMS services by a roaming UE in a visiting network, according to an exemplary embodiment of the present invention

### DETAILED DESCRIPTION OF THE INVENTION

Reference will now be made in detail to exemplary embodiments of the present invention, examples of which are illustrated in the accompanying drawings.

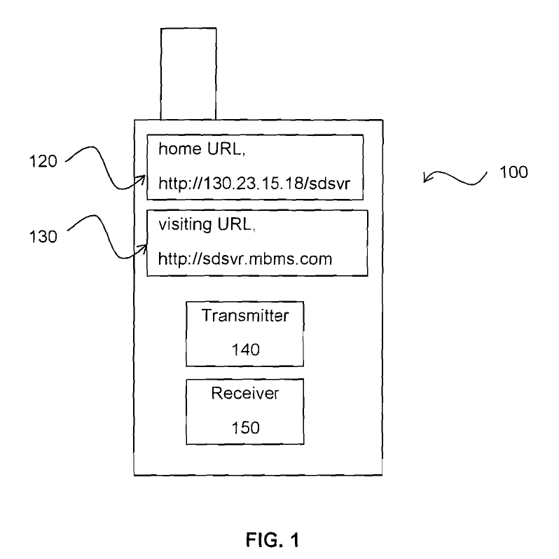

FIG. 1 depicts a User Equipment (UE) 100 according to an exemplary embodiment of the present invention. The UE 100 may function as a telephone, such as a Voice over Internet Protocol (VoIP) telephone or wireless telephone, a portable television, a Personal Digital Assistant (PDA), an MPEG-1 Audio Layer 3 (MP3) player, and/or a handheld gaming machine, for example.

Further, the UE 100 may be operable in a 3rd Generation Partnership Project (3GPP) architecture. Note, however, that the present invention is not limited to this particular architecture, but may be compatible with other communication architectures that support communications using Uniform Resource Locators (URLs).

The UE 100 may have a plurality of URLs 120, 130 associated with the UE 100. A Device Management (DM) server (not shown) may be used in the present invention, as known in the related art, that defines the Management Object (MO) node (not shown) which contains the information needed for service discovery, such as a home URL address 120. In FIG. 1, for example, http://130.23.15.18/sdsvr.html.

The UE 100 may also be associated with a “well known” (standardized or by other means) URL 130 for use as a visiting URL. An example of such a visiting URL 130 is shown in FIG. 1 as http://sdsvr.mbms.com.

This visiting URL 130 may not physically point to one, unique address. Rather, the visiting URL 130 may be just symbolic, although it is preferable that the visiting URL 130 be a valid URL name. Thus, the visiting URL 130 may sometimes be referred to and used interchangeably as a symbolic URL herein.

The UE 100 may include a transmitter 140 and a receiver 150. The transmitter 140 may be structured to transmit a MBMS service discovery request. The service discovery request may include the home URL 120 and the visiting URL 130.

The receiver 150 may be structured to access the MBMS services in both a home and visiting network during roaming of the UE 100.

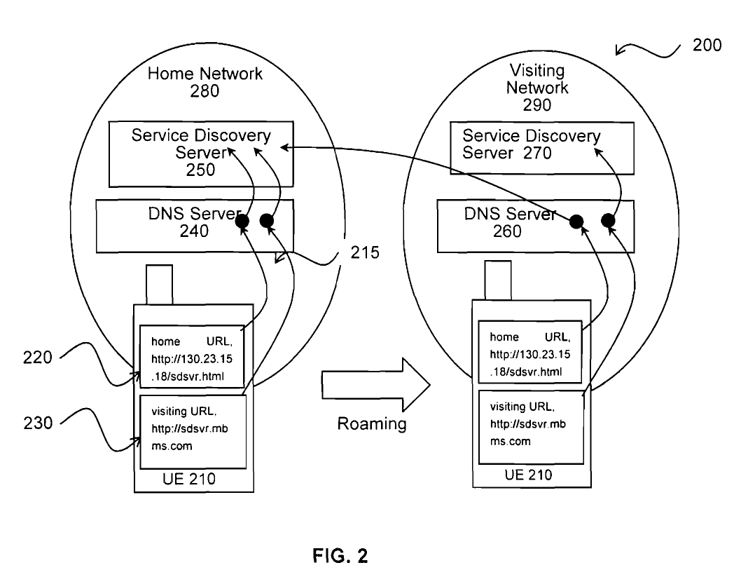

FIG. 2 illustrates a MBMS system 200 wherein a roaming UE 210 is operable to access a home network 280 and visiting network 290 of the system according to an exemplary embodiment of the present invention.

As shown in FIG. 2, UE 210 may transmit a request 215 for discovery of and access to MBMS services within a network 280/290 in which the UE 210 is located. The request may include the home URL 220 and the symbolic URL 230 associated with the UE 210.

When the UE 210 is located in the home network 280, a home Domain Name System (DNS) server 240 may be used to resolve the addresses of both the home URL 220 and the symbolic URL 230, and forward the request to a home MBMS Service Discovery server 250. The home MBMS Service Discovery server 250 may accordingly assess the request, and determine the MBMS services that the UE 210 may access.

When the UE 210 is roaming in the visiting network 290, a visiting (local) DNS server 260 may be used to resolve the addresses of the home URL 220 and the symbolic URL 230. That is, for example, the local network's DNS server 260 will resolve the symbolic URL 230 to an address of its local MBMS Service Discovery server 270, whereupon the roaming UE 210 may obtain the information needed for discovery of and access to MBMS services.

Of course, should the symbolic URL 230 not be able to be resolved by the local network DNS server 260, there would be no MBMS services offered to the visiting UE 210.

Further, when the UE 210 is roaming in the visiting network 290, the local DNS server 260 may be used to resolve the address of the home URL 220 and forward the request to the home Service Discovery server 250 as shown in FIG. 2. The home MBMS Service Discovery server 250 may accordingly assess the request, and determine the MBMS services that the UE 210 may access in its roaming environment.

As such, the present invention makes it possible for the UE 210 to discover and access home MBMS services both when it is within its home network 280 and when it is roaming. When the UE 210 is roaming to a visiting network 290, the UE 210 may also access the local MBMS service. Because of this exemplary feature, the present invention may be preferable over broadcasting services, such as Digital Video Broadcasting—Handheld (DVB-H), where a roaming UE can only access local service in the visiting network.

In another exemplary embodiment of the invention, when the UE 210 is located in a network 280/290 having a plurality of operators (not shown), each of a plurality of DNS servers (not shown) associated with at least one of the plurality of operators resolve the symbolic URL 230 differently from one another. In this manner, the invention provides a solution of multiple operators in a visiting area. That is, the final service discovering address may be dependent on the local operator to which the UE is attached. This means that if the UE selects a different operator in the visiting network, there will be a different local DNS for resolving the visiting URL address, and the UE will automatically receive different service discovering information, which is a reasonable fit for current commercial networks.

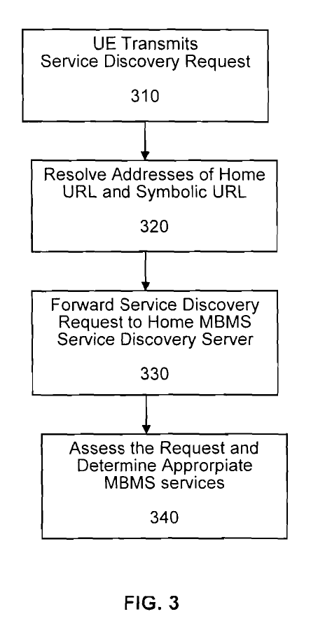

FIG. 3 depicts a method for discovering and accessing MBMS services by a UE in a home network, according to an exemplary embodiment of the present invention.

In step 310, a UE transmits an MBMS service discovery request. The service discovery request may include a home URL and a visiting or symbolic URL.

In step 320, a home DNS server may be used to resolve the addresses of both the home URL and symbolic URL. When the UE is located in a home network, in exemplary embodiments, there would be no need to resolve the symbolic URL.

Once the addresses are resolved, in step 330, the service discovery request is forwarded to a home MBMS Service Discovery server. In step 340, the home MBMS Service Discovery server may assess the request and determine the MBMS services that the UE may access in the home network.

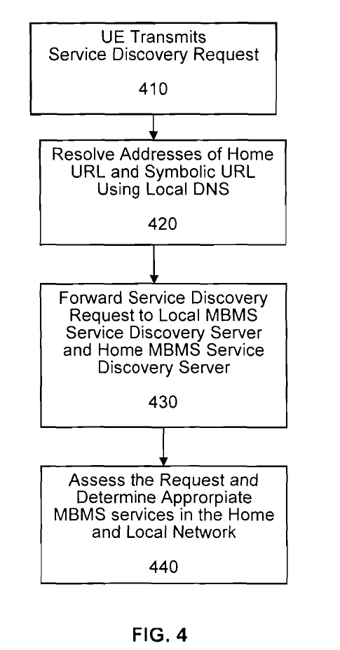

FIG. 4 depicts a method for discovering and accessing MBMS services by a UE in a visiting network, according to an exemplary embodiment of the present invention.

In step 410, a UE transmits a MBMS service discovery request. The service discovery request may include a home URL and a visiting or symbolic URL.

In step 420, a local DNS server may be used to resolve the addresses of both the home URL and symbolic URL. The symbolic URL is resolved by the local DNS server to a local URL.

Once the addresses are resolved, in step 430, the service discovery request is forwarded to a local MBMS Service Discovery server as well as the home MBMS Service Discovery Server. In step 440, both the local MBMS Service Discovery server and home MBMS Service Discovery server may assess the request and determine the MBMS services that the UE may access in the local and home networks. Accordingly, the present invention makes it possible for the UE to discover and access home MBMS services both when it is within its home network and when it is roaming.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method for discovering and accessing Multimedia Broadcast/Multicast Service (MBMS) services by a roaming user equipment (UE), the method comprising:
receiving a request from the UE to discover one or more of the MBMS services, wherein the request includes a plurality of Uniform Resource Locators (URLs), the URLs including a home URL and a symbolic URL; and
in response to receiving the request, assessing the URLs to determine the MBMS services that the UE may access.

2. The method for discovering and accessing MBMS services by a roaming UE according to claim 1, wherein when the UE is located in a visiting network, the symbolic URL is resolved by a local Domain Name System (DNS) server to a local URL, forwarded to a local MBMS Service Discovery server, and assessed to determine the MBMS services that may be accessed by the UE in the visiting network.

3. The method for discovering and accessing MBMS services by a roaming UE according to claim 1, wherein when the UE is located in a home network, the home URL is resolved by a home DNS server, forwarded to a home MBMS Service Discovery server, and assessed to determine the MBMS services that may be accessed by the UE in the home network.

4. The method for discovering and accessing MBMS services by a roaming UE according to claim 1, wherein when the UE is located in a visiting network, the home URL is resolved by a local DNS server, forwarded to a home MBMS Discovery server, and assessed to determine the MBMS services that may be accessed by the UE in a home network.

5. The method for discovering and accessing MBMS services by a roaming UE according to claim 1, wherein when the UE is located in a visiting network, the home URL is resolved by a local DNS server, forwarded to a home MBMS Service Discovery server, and assessed to determine the MBMS services that may be accessed by the UE in a home network, and the symbolic URL is resolved by the local DNS server to a local URL, forwarded to a local MBMS Service Discovery server, and assessed to determine the MBMS services that may be accessed by the UE in the visiting network.

6. The method for discovering and accessing MBMS services by a roaming UE according to claim 1, wherein the symbolic URL is not associated with one, unique address.

7. The method for discovering and accessing MBMS services by a roaming UE according to claim 1, wherein when the UE is located in a network having a plurality of operators, each of a plurality of DNS servers associated with at least one of the plurality of operators resolve the symbolic URL differently from one another.

8. The method for discovering and accessing MBMS services by a roaming UE according to claim 7, wherein the differing resolution by each of the DNS servers results in differing assessments of the MBMS services that may be accessed by the UE.

9. A Multimedia Broadcast/Multicast Service (MBMS) system, comprising:
User Equipment (UE) operable in a roaming environment, the UE including a transmitter structured to transmit a MBMS service discovery request, the service discovery request including a plurality of Uniform Resource Locators (URLs) associated with the UE, the URLs including a home URL and a symbolic URL;
a plurality of Domain Name Server (DNS) servers structured to receive and resolve the URLs transmitted by the UE; and
a plurality of MBMS Service Discovery servers structured to receive the resolved URLs and assess the MBMS services that may be accessed by the UE.

10. The MBMS system according to claim 9, wherein when the UE is located in a visiting network, a local DNS server of the plurality of DNS servers is operable to resolve the symbolic URL to a local URL and provide the local URL to a local MBMS Service Discovery server of the plurality of MBMS Service Discovery servers, that assesses the local URL to determine the MBMS services that may be accessed by the UE in the visiting network.

11. The MBMS system according to claim 9, wherein when the UE is located in a home network, a home DNS server of the plurality of DNS servers is operable to resolve the home URL and provide the home URL to a home MBMS Service Discovery server of the plurality of Service Discovery servers, that assesses the home URL to determine the MBMS services that may be accessed by the UE in the home network.

12. The MBMS system according to claim 9, wherein when the UE is located in a visiting network, a local network DNS server of the plurality of DNS servers is operable to resolve the home URL and forward the home URL to a home MBMS Service Discovery server of the plurality of Service Discovery servers, that assesses the home URL to determine the MBMS services that may be accessed by the UE in a home network.

13. The MBMS system according to claim 9, wherein when the UE is located in a visiting network, a local DNS server of the plurality of DNS servers is operable to resolve the home URL and forward the home URL to a home MBMS Service Discovery server of the plurality of Service Discovery servers, that assesses the home URL to determine the MBMS services that may be accessed by the UE in a home network, and, the local DNS server of the plurality of DNS servers is further operable to resolve the symbolic URL to a local URL and provide the local URL to a local MBMS Service Discovery server of the plurality of Service Discovery servers, that assesses the local URL to determine the MBMS services that may be accessed by the UE in the visiting network.

14. The MBMS system according to claim 9, wherein the symbolic URL is not associated with one, unique address.

15. The MBMS system according to claim 9, further comprising a network having a plurality of operators, wherein each of the DNS servers associated with at least one of the plurality of operators resolve the symbolic URL differently from one another.

16. The MBMS system according to claim 15, wherein the differing resolution by each of the DNS servers results in differing assessments of the MBMS services that may be accessed by the UE in the visiting network.

17. User Equipment (UE) operable to discover and access Multimedia Broadcast/Multicast Service (MBMS) services in a roaming environment, the UE comprising:
a transmitter structured to transmit a MBMS service discovery request, the service discovery request including a plurality of Uniform Resource Locators (URLs) associated with the UE, the URLs including a home URL and a symbolic URL.

18. The UE according to claim 17, further comprising a receiver operable to access the MBMS services in both a home and visiting network during roaming.

19. The UE according to claim 17, wherein the symbolic URL associated with the UE is resolved by a DNS server to a local URL that is assessed to determine the MBMS services that may be accessed by the UE in a visiting network.

20. The UE according to claim 17, wherein the symbolic URL is not associated with one, unique address.
